(19) United States
(12) Patent Application Publication
(10) Pub. No.: US 2016/0202997 A1
(43) Pub. Date: Jul. 14, 2016

(54) PORTABLE DEVICE OPERATING SYSTEM

(71) Applicant: SHENG-CHIA OPTICAL CO., LTD., Taipei (TW)

(72) Inventor: Jinn-Yuan LAY, Taipei (TW)

(21) Appl. No.: 14/593,880

(22) Filed: Jan. 9, 2015

(51) Int. Cl. G06F 9/44; G06F 1/32

(52) U.S. Cl. CPC G06F 9/4406; G06F 9/4418; G06F 1/3246; G06F 1/3287; G06F 1/3243

(57) ABSTRACT

A portable device booting system consists of a booting firmware and a circuit system which includes a microprocessor, a sensor and a power control circuit. The booting is performed by a booting gesture. When the booting gesture is applied, the position of the portable device is changed accordingly that causes sensor physical values changed and also triggers the microprocessor from sleep mode to working state. Then the microprocessor reads the sensor physical value to verify if it is compliant with the defined boot up orientation as well as the sequential. If negative, the microprocessor will set the sensor and itself getting back to the sleep mode. Once the applied booting gesture meets the defined orientation and sequential, the microprocessor will release the turning ON signal to the utility circuit and power control circuit to turn the device ON.

### BACKGROUND OF THE INVENTION

1. Field of the Invention

The present invention relates to portable device operating technology and more particularly, to a portable device operating system, which provides the user with convenience to boot up the portable device by a booting gesture without pressing any button or sliding any switch.

2. Description of the Related Art

The widely used modern electronic devices are designed to be turned on through a switch or remote controller. Further, commercial portable devices normally use battery to provide the necessary working power supply. In order to reduce power consumption and to extend battery lifespan, the current consumption of a handheld electronic product or device can be down to micro ampere when the portable product or device in the shutdown or suspend state, and the portable electronic product or device can be booted up after the user switching on the switch. However, the new generation of portable devices are created having the light, thin, short and small characteristics. In these portable devices, any button on the device or periphery will impact the neat appearance. In case if the button size is too small, it is inconvenient to use. Therefore, smart phones, tablet computers and many other advanced portable devices feature touch screen technologies by means of clicking a finger or stylus on the touchscreen, or tapping on the desired point on the touchscreen and sliding the finger, to eliminate using a button. Even that, there is a power button on the portable device for turning ON before touch screen can be activated. In terms of industrial design and neat appearance, there is room for improvement.

Therefore, it is desirable to provide a portable device that eliminates the button for power ON and operating to reduce the dimension of the device as well as the improving of using convenience.

### SUMMARY OF THE INVENTION

The present invention has been accomplished under the circumstances in view. It is therefore the main object of the present invention to feature a portable device operating system, which provides user with the convenience to boot up the portable device by a booting gesture, for example, positioning the device from portrait to landscape, tilting the device with a certain degree to the earth, tapping or double tapping the device with desired strength, shaking the device along a certain direction or aiming the device to the pre-defined orientations sequentially.

To achieve this and other objects of the present invention, a portable device operating system in accordance with the present invention comprises a portable device, and an operation procedure in terms of firmware program for the portable device. The portable device comprises an utility circuit, a circuit system containing a microprocessor adapted for running system software and application software, a main power source electrically connected to the circuit system, a power control circuit electrically connected to the power source, and a sensor electrically connected to the power supply circuit and the microprocessor. The sensor is configured with the physical threshold values by the connected microprocessor. When the boot up gesture is applied, the position of the portable device is changed accordingly and that causes sensor physical values changed that also triggers the microprocessor from sleep mode by sending a “Power ON” interrupt from the sensor. Then the microprocessor reads the sensor physical value to verify if it is compliant with the defined boot up orientation as well as the sequential. If negative, the microprocessor will set the sensor and itself getting back to the sleep mode. Once the applied booting gesture meets the defined orientation and sequential, the microprocessor will immediately drive the utility circuit to the ON state by supplying the power and, or releasing the turning ON signal to the utility circuit.

While the microprocessor is in the sleep mode, it shuts down all the internal blocks except the interrupt port which will activate the microprocessor to the working state upon receiving the signal from the sensor. The microprocessor consumes only several micro ampere current in this condition. The sensor configuration indicating the sensor is set to send the interrupt signal to the microprocessor with a defined event. This configuration helps the sensor keep in the low power state since it will stop the sensor from outputting the physical data unless the event is valid. And therefore, the portable device is functionally OFF without performing the booting gesture since the total power consumption of this portable device is less than a hundred micro ampere before the circuit system turns ON.

The sensor physical value is by means of the acceleration in an accelerometer, the magnet strength in a magnetometer, the device heading read from the gyroscope and the pressure on the device. The configured threshold value forms a motion rule of the gesture. The motion sequential can be programmed and is varied for different portable device applications.

Further, the portable device can be an intelligent electronic bracelet, smart watch, smart phone or tablet computer and the peripherals; the microprocessor in the circuit system can be a microcontroller unit (MCU) or a sensor integrated SoC (System on a Chip) which connects to the power control circuit, and that provides the power to the microprocessor, the sensor and the circuit system in the portable device; the circuit system of the portable device can be a system-on-a-chip having the microprocessor and the sensor integrated therein; the main power source of the portable device can be a battery, rechargeable battery or lithium battery.

Further, the boot gesture can be defined from the sensor readings in terms of the acceleration differential vector from the moving and tapping the portable device; the differential orientation vector from rotating and swinging the portable device; and the magnetometer differential vector from positioning the portable device. The booting gesture is a single motion or a sequential combination of different motions.

Thus, the sensor of the portable device can be one of accelerometer, magnetometer, gyroscope and pressure sensor, or a combination thereof.

### BRIEF DESCRIPTION OF THE DRAWINGS

FIGS. 1 through 4 are respectively a simplified block diagram of a portable device, a derivative block diagram of a portable device, an alternative block diagram of the portable device and a multiple sensor combination diagram of the portable device.

### DETAILED DESCRIPTION OF THE PREFERRED EMBODIMENT

The present invention is constituted by a portable device 1 and the operating program running in the portable device. The portable device 1 comprises a utility circuit 15 which performs the major function of the portable device, a sensor 2, a circuit system 11 which contains a microprocessor 14 performing the booting control of the portable device 1, and a power control circuit 13 which controls a power source 12 for the power supply to all the functional blocks in the portable device mentioned above. The circuit system 11 connects to the sensor 2, the power control circuit 13 and the utility circuit 15. The microprocessor 14 will also be the control unit for the utility circuit 15;

there will be other processors in the utility circuit 15 if the microprocessor 14 is dedicated for the booting control. The procedures to boot up the portable device 1 with gesture are as follows:

(A) The portable device 1 is shut down, or in the suspend state, where

(B) the power control circuit 13 provides the power to the microprocessor 14 and the sensor 2, and both the microprocessor 14 and the sensor 2 are in the sleep mode; while the other functional blocks in the portable device 1 are OFF or suspended which consume less power than sleep mode.

(C) Perform the booting gesture on the portable device 1. For example, hold the portable device 1 vertically, flip its face down, and then flip it back to face up. Once the sensor 2 detects the movement, it wakes up the microprocessor 14 by sending an interrupt signal to turn it ON. The microprocessor 14 then reads the vertical gravity value from the sensor 2 to verify if it is positioned vertically. If negative, the microprocessor 14 sets the sensor 2 and itself to sleep mode. In case the first booting position is confirmed, the microprocessor 14 will verify the remaining movement by reading the physical data from the sensors 2. In this example, the duration when the portable device 1 is travelling from standing vertical to face down, the gravity alone the vertical direction will be decreased from 1G (G=9.8 msec²) around to zero G with the weight of cosθ, whileθ is the travelling angle. The third step to flip it back to face up can be verified by same algorithm or checking the acceleration at any certain angle of travelling. It is applicable with the reading from a gyroscope sensor for the orientation of the portable device 1. In case the booting gesture identically meets the defined movement, the microprocessor 14 sends the command to power control circuit 13 and executes the procedure (E).

(D) In any case that the booting gesture fails to confirm the booting movement during the process, the microprocessor 14 will then sets the sensor 2 and itself back to the sleep mode.

(E) The power control circuit 13 is activated by the microprocessor 14, enabling the power source 12 to provide the power to the utility circuit 15.

(F) Thus the portable device 1 is functionally ON.

The portable device 1 can be an intelligent electronic bracelet, smart watch, smart phone or tablet computer or any handheld device. The circuit system 11 is featured with the operating system program and the application program to perform the function of the portable device 1. It is applicable that the circuit system 11 only works for booting the system, and thus, there will be another processor which is featured with the operating system program application program in the utility circuit 15.

The aforesaid booting gesture is one of the application examples. In case of rotating the portable device 1, it can be verified by acceleration and orientation. If moving the portable device 1 up and down or swing, the acceleration data is read as simple harmonic motion characteristics. The movement to boot up the portable device 1 can be configured with gravity, acceleration, orientation, magnetic strength or atmospheric pressure in terms of flipping, swing, tapping, shaking, vibrating, etc. In order to prevent the false booting from unexpected movements or motions, the sensor 2 is configured with the threshold conditions from sleep to working state; and the gesture can be the combined and sequential motions rather than a single motion.

The aforesaid booting procedure (A) through (F), there are three checking positions to the microprocessor 14 for booting confirmation, this multiple judgments is an example for a more reliable application of this invention, but not intended for use to limit the scope of the invention.

The circuit system 11 and the sensor 2 which monitor the booting gestures consume the power of one hundred micro-ampere or less in the sleep mode. As the microprocessor 14 recognizes the booting gesture, it commands the power control circuit 13 to turn the portable device 1 ON, and the operating current will be raised to normal condition.

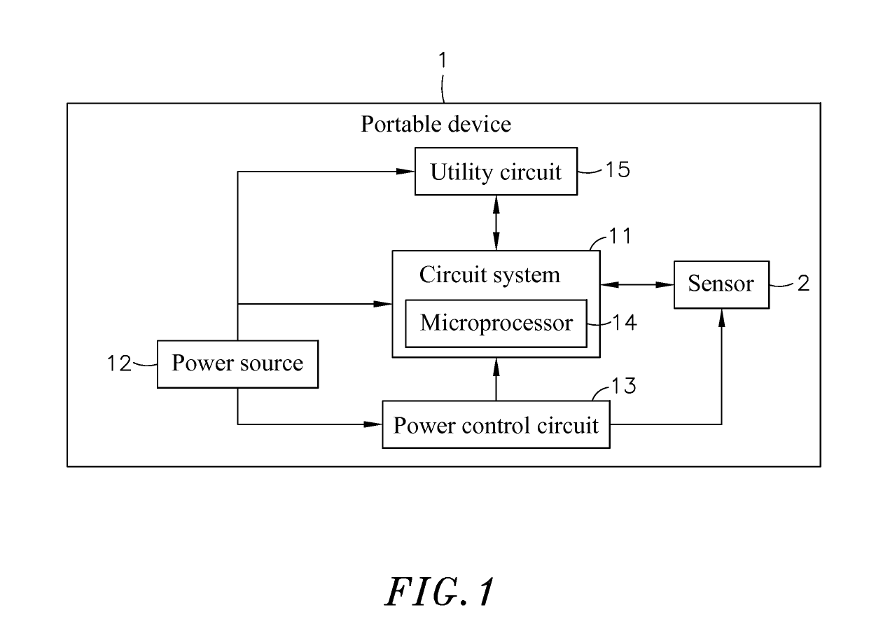

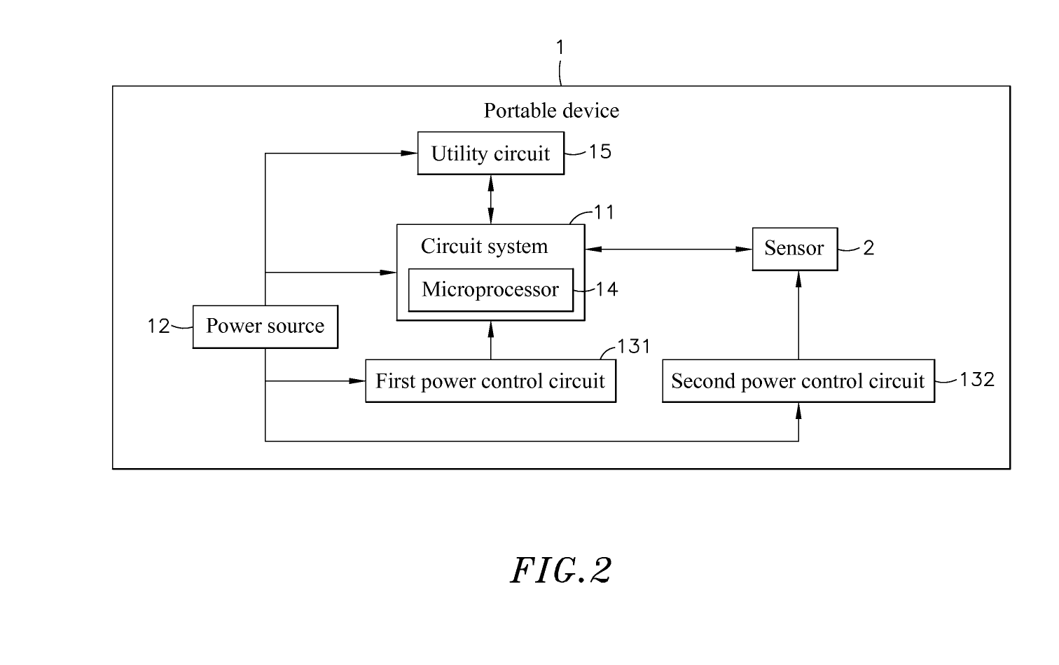

Referring to the FIG. 2, the power control circuit 13 in the FIG. 1 is configured comprising a first power control circuit 131 and a second power control circuit 132. The first power control circuit 131 connects to the power source 12 and the microprocessor 14 while the second power control circuit 132 connects to the sensor 2 and the power source 12. The power source 12 also connects to the utility circuit 15. This configuration provides even less power consumption than FIG. 1. It only keeps the sensor 2 in the sleep mode and suspends all the other functional blocks before the booting gesture is confirmed by the microprocessor 14.

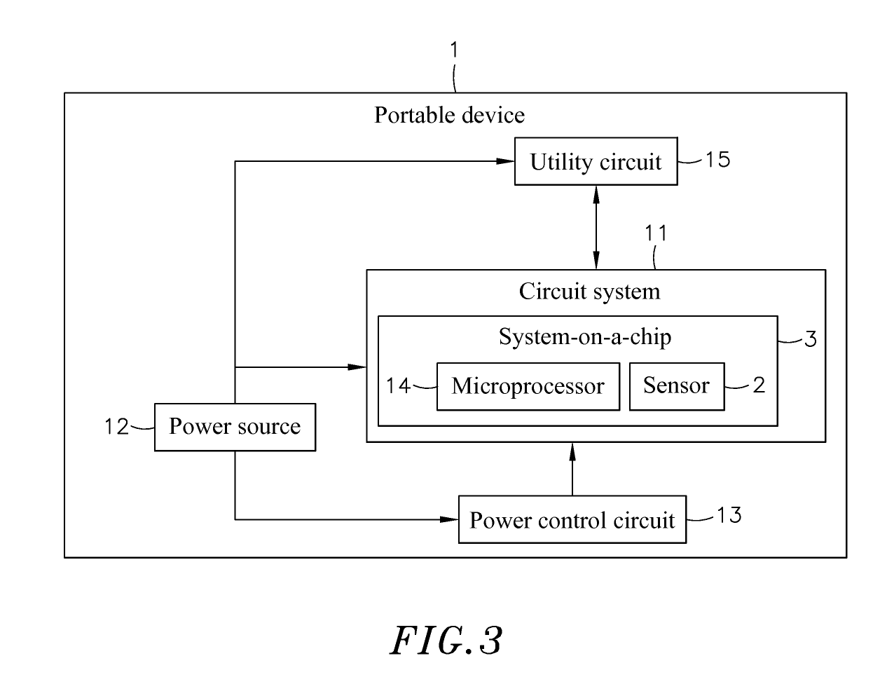

The microprocessor 14 and the sensor 2 can be integrated as a system-on-a-chip 3 (SoC) as shown in the FIG. 3. The system-on-a-chip 3 connects to the power control circuit 13. This integrated system-on-a-chip 3 saves the space for the portable device 1. And the circuit system 11 can be made in the form of a module for booting control.

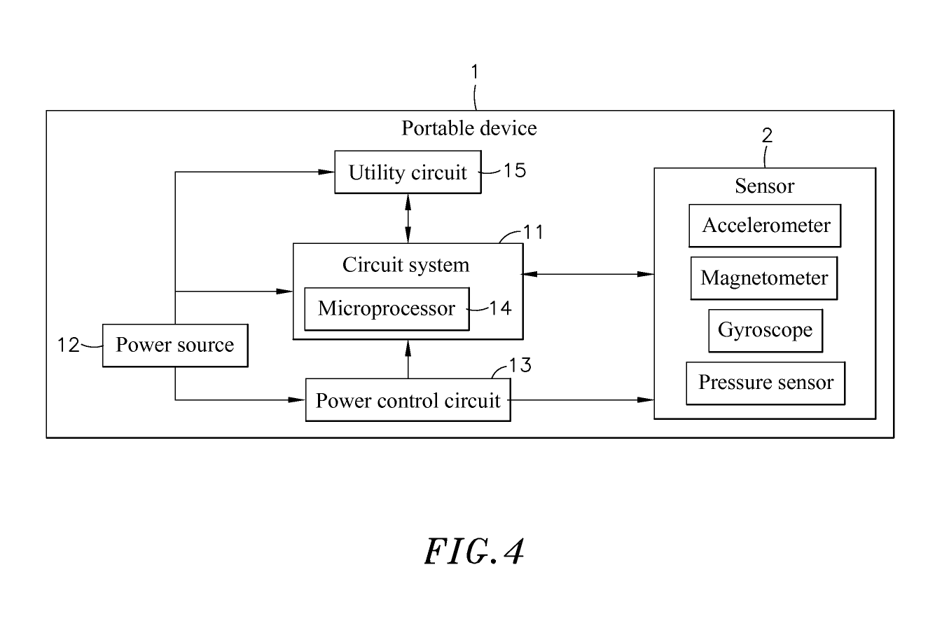

Referring to FIG. 4, the sensor 2 that is electrically connected to the microprocessor 14 in the circuit system 11 of the portable device 1 can be an accelerometer, a magnetometer, a gyroscope, a pressure sensor, or their combinations for detecting physical changes of the portable device 1. Further, two or more than two sensors 2 can be used and electrically connected to the microprocessor 14 to detect the position and orientation changes of the portable device 1. This multiple sensors configuration contributes the complex and precision attitude of the portable device 1 in the application, such as the sequential combination of positioning the device from portrait to landscape, tilting the device with certain degree to the earth, tapping or double tapping the device with desired strength, shaking the device along a certain direction or aiming the device to the pre-defined orientations.

What the invention claimed is:

1. A portable device operating system, comprising a portable device, and an operation procedure in terms of firmware program for said portable device, said portable device comprising an utility circuit, a circuit system containing a microprocessor adapted for running system software and application software, a main power source electrically connected to said circuit system, a power control circuit electrically connected to said power source, and a sensor electrically connected to said power supply circuit and said microprocessor, said sensor being configured with physical threshold values by the connected said microprocessor, said operation procedure comprising the steps of:
(A) initializing said portable device in shut down, or the suspend state;
(B) both said microprocessor and said sensor are in the sleep mode, and powered by the said power control circuit;
(C) performing a defined booting gesture on said portable device, the position of said portable device is changed accordingly and that causes sensor physical values changed that also triggers said microprocessor from sleep mode by sending a “Power ON” interrupt from sensor, and then said microprocessor reading the sensor physical value to verify if it is compliant with the defined boot up orientation, acceleration and gravity as well as the sequential, and then proceeding to step (D) if negative, or step (E) is positive;
(D) said booting gesture fails to confirm the booting movement during the process, said microprocessor setting said sensor and itself back to the sleep mode;
(E) conducted by said microprocessor, said power control circuit enabling said power source to provide the power to said utility circuit; and
(F) said portable device being functionally ON.

2. The portable device operating system as claimed in claim 1, wherein said portable device is an intelligent electronic bracelet, smart watch, smart phone or tablet computer.

3. The portable device operating system as claimed in claim 1, wherein said microprocessor of said circuit system of said portable device is a microcontroller unit (MCU) or single-chip microcomputer.

4. The portable device operating system as claimed in claim 1, wherein said circuit system of said portable device is a system-on-a-chip having said microprocessor and said sensor integrated therein.

5. The portable device operating system as claimed in claim 1, wherein said defined booting gesture performed on said portable device in steps (C), (D) and (E) to drive said portable device is configured with physical value of gravity, acceleration, magnetic strength or atmospheric pressure of the said portable device in terms of flipping, swing, tapping, shaking, vibrating, aiming to certain orientation, rotating, and positioning between portrait and landscape.

6. The portable device operating system as claimed in claim 1, wherein said sensor of said portable device is selected from the group of accelerometer, magnetometer, gyroscope and pressure sensor.

7. The portable device operating system as claimed in claim 1, wherein said main power source of said portable device is selected from the group of battery, rechargeable battery and lithium battery.

8. The portable device operating system as claimed in claim 1, wherein in step (B), said power control circuit provides the necessary working power supply from said main power source to said microprocessor and said sensor.

9. The portable device operating system as claimed in claim 1, wherein said power control circuit is configured comprising a first power control circuit and a second power control circuit, said first power control circuit connecting to said power source said microprocessor while said second power control circuit connecting to said sensor and said power source.

10. The portable device operating system as claimed in claim 1, wherein said physical value is by means of the gravity, acceleration, orientation, geomagnetic strength, and atmospheric pressure of the said portable device.
